(19) United States
(12) Patent Application Publication
(10) Pub. No.: US 2022/0281213 A1
(43) Pub. Date: Sep. 8, 2022

(54) BUILDING PANEL AND A METHOD TO PRODUCE SUCH A BUILDING PANEL

(71) Applicant: Välinge Innovation AB, Viken (SE)

(72) Inventors: Pontus GAMSTEDT, Kattarp (SE); Christoffer NILSSON, Helsingborg (SE)

(73) Assignee: Välinge Innovation AB, Viken (SE)

(21) Appl. No.: 17/686,838

(22) Filed: Mar. 4, 2022

(30) Foreign Application Priority Data
Mar. 4, 2021 (SE) 21502497

(51) Int. Cl. B32B 27/08; B32B 37/10; B32B 37/06; B32B 27/30; B32B 27/20; B32B 27/32; B32B 19/04; B32B 7/027; E04F 15/10

(52) U.S. Cl. CPC B32B 27/08; B32B 37/10; B32B 37/06; B32B 27/304; B32B 27/20; B32B 27/32; B32B 19/045; B32B 7/027; E04F 15/105; E04F 15/107; B32B 2419/00; B32B 2307/304; B32B 2250/40; B32B 2264/104; B32B 2264/101; B32B 2307/732

(57) ABSTRACT

A building panel, such as a floor panel, including a core including at least one or more of a thermoplastic material, a thermoset material, a mineral based material or a combination thereof. The building panel further including a first layer arrangement, arranged on one side of the core, having a surface layer and a thermally insulating layer, where the thermally insulating layer is arranged between the core and the surface layer.

### CROSS REFERENCE TO RELATED APPLICATIONS

The present application claims the benefit of Swedish Application No. 2150249-7, filed on Mar. 4, 2021. The entire contents of Swedish Application No. 2150249-7 are hereby incorporated herein by reference in their entirety.

### FIELD OF THE INVENTIVE CONCEPT

The present inventive concept relates to a building panel, e.g. a flooring panel and especially to the laminated structure of such a building panel. Further, the present inventive concept relates to a method for producing such building panel.

### TECHNICAL BACKGROUND

Building panels such as Luxury Vinyl Tiles (LVT) or Stone Plastic Composite panels (SPC panels) are examples of today very popular building panels, especially flooring panels, which have the advantages of being durable and easy to maintain.

A SPC panel is a more rigid panel than a LVT panel, having an E-modulus of 2 000-10 000 MPa often containing inorganic fillers, such as chalk, at an amount of 50-90 wt %. A LVT panel usually has an E-modulus of less than 2 000 MPa since it often contains plasticizer of an amount of 1-20 wt %.

Building panels often used today often include a board of a highly filled thermoplastic material, an inorganic material, such as cement of MgO, an organic material, such as HDF, wood, cellulose or natural fibres, or other types of composite materials.

However, such panels often have limitations and disadvantages in their manufacturing process, as the core of these panels are often made of highly filled thermoplastic material, thermosetting materials or mineral based materials, as previously said. When combining these types of core materials with layers, e.g. surface layers, containing thermosetting materials such as melamine formaldehyde-based resins or urea formaldehyde-based coatings, the manufacturing process demands a lot of heat to be able to create the laminated, layered structure of the building panels. The heat of the manufacturing process is key to creating the desired layers. However, high temperatures may have an undesirable effect on the core of LVT or SPC panels. One example is that a SPC board, which often consists of more than 70 wt % chalk, steals a lot of the applied heat as it has a rather high heat conductivity, making the laminating process and the forming of the building panels very inefficient as a lot of the heat gathers in the SPC board instead of in the layers to be laminated. Further, it would also take a lot of time cooling the panel after the lamination process. Another example is if the core is made of a thermoplastic material, which is prone to deform and change shape under the influence of high temperatures. This will result in panels having an unpredictable bend which is of course not an advantage when installing e.g. a floor. The undesirable ability to deform under high temperatures will also affect a panel having a décor layer. If the core deforms it will affect the result of the décor layer of the finished building panel. A décor layer demands a repeatable manufacturing process and a core which is deforming under heat would certainly make that very difficult to achieve. Such a deformation would also increase the risk of defects like cracks and undesirable tensions in the material and in the panel.

### SUMMARY

An object of the present inventive concept is to provide improvements over known art. This object is achieved by a technique defined in the appended independent claims; certain embodiments being set forth in the related dependent claims.

An object of the present inventive concept is to improve the manufacturing process for building panels having a core of a highly filled thermoplastic material, an inorganic material, such as cement of MgO, an organic material, such as HDF, wood, cellulose or natural fibres, or other types of composite materials.

An object of the present inventive concept is to improve the manufacturing process for building panels having an SPC core or similar.

Another object of the present inventive concept is to provide a manufacturing process which improves the repeatability of the building panels shape and design.

In a first aspect of the present inventive concept, there is provided a building panel, such as a floor panel, including a core comprising at least one or more of a thermoplastic material, a thermoset material, a mineral based material or a combination thereof. Further the building panel includes a layer arrangement, arranged on one side of the core comprising a surface layer and a thermally insulating layer, wherein the thermally insulating layer is arranged between the core and the surface layer.

An advantage with the present inventive concept is that the core is insulated and protected from external heat, which may affect or even damage the core depending on the chosen material of the core. The possibilities of the choosing a desirable material for the core is increased by having a thermally insulating layer.

In an embodiment the core includes at least 10 wt %, at least 15 wt % or at least 20 wt % of a thermoplastic material.

In another embodiment the core includes 10-40 wt %, 15-35 wt %, or 20-30 wt % of a thermoplastic material.

In yet another embodiment the core includes 10-70 wt %, 20-60 wt % or 25-50 wt % of a thermoset material.

In yet another embodiment the core include at least 50 wt %, at least 60 wt % or at least 70 wt % of a mineral based material.

In an embodiment the thermally insulating layer comprises at least one or more of a thermoplastic material, a thermoset material, or a combination thereof. These types of materials have excellent insulating properties as they have a low thermal conductivity.

In another embodiment the thermally insulating layer includes a filler wherein the filler comprises at least one or more of an organic filler, an inorganic filler, or a combination thereof. Many fillers have the advantages of e.g. improving layer properties such as thermal conductivity, material stability in the layer, etc. and often being cost efficient.

In yet another embodiment the filler is calcium carbonate (CaCO₃). This type of filler is especially cost efficient and easy to get a hold of and it also decreases movements in the material if exposed to external heat, compared to a layer made of only a thermoplastic or thermoset material. The thermally insulating layer may include 1-40 wt. % calcium carbonate (CaCO₃).

In an embodiment, the filler may comprise gas-containing elements, such as glass bubbles. The advantage of gas-containing elements and e.g. glass bubbles is that the thermal conductivity of the insulating layer is decreased even more, increasing the insulating ability of the layer. The thermally insulating layer may include 1-20 wt. % gas-containing elements, or 5-15 wt. % gas-containing elements.

In yet another embodiment the second layer comprises a filler comprising a combination of calcium carbonate (CaCO₃) and gas-containing elements. By combining two different fillers, such as chalk/calcium carbonate and gas-containing elements the thermally insulating layer can be formed having several desirable features. for example, the thermal conductivity may be decreased by the gas-containing elements and the chalk/calcium carbonate can lower the cost of the thermally insulating layer.

In another embodiment, the thermally insulating layer include 30-70 wt. % of an organic filler. Organic fillers are often cost efficient and easy to get a hold of. They can also decrease the thermal conductivity of the layer.

In an embodiment the thermally insulating layer has a lower thermal conductivity than the core.

In an embodiment, the thermally insulating layer has a thermal conductivity of less than 1 W/mK, preferably a thermal conductivity of less than 0.8 W/mK, and more preferably a thermal conductivity of less than 0.5 W/mK.

The thermally insulating layer may have a thickness of 0.1-3 mm, preferably a thickness of 0.2-2 mm, and even more preferably thickness of 0.5-1.5 mm.

In another embodiment, the building panel further comprises a second layer arrangement arranged on one side of the core, opposite of the first layer arrangement. The second layer arrangement may have a second surface layer and a second thermally insulating layer, where the second thermally insulating layer is arranged between the core and the second surface layer. Advantages of having this second layer arrangement on the opposite side of the core is to insulate the core from both sides and preferably to balance the building panel and to avoid e.g. shape deformations of the panel, such as cupping.

In a second aspect of the inventive concept, there is provided a method to manufacture a building panel, such as a floor panel, comprising:
joining a first material and a second material to form a first layer and a second layer of a semi-finished panel, wherein the first material comprises at least one or more of a thermoplastic material, a thermoset material, a mineral based material or a combination thereof,
applying a third layer on the second layer, and
applying heat and pressure to form the building panel,

wherein the first layer forms a core of the building panel, and the third layer forms a surface layer of the building panel, and

wherein the second layer forms a thermally insulating layer between the first layer and the applied heat and pressure.

An advantage with the present inventive concept is that the first layer is insulated and protected from external heat during the manufacturing process, which may affect or even damage the first layer depending on the chosen material of the first layer. The possibilities of the choosing a desirable material for the first layer is increased by having a thermally insulating layer which decreases the heat transfer between the heat source and the first layer. A further advantage is that the thermally insulating layer also has a beneficial effect on the third layer. The appearance of the third layer, being a surface layer in the finished building panel, achieved by the manufacturing process is more repeatable and predictable as the thermally insulating layer makes sure that the heat which stays in the second and third layer is increased and decreases the risk of deforming the first layer when heat and pressure is applied, which in turn could lead to irregularities in the third layer.

In an embodiment the first material includes at least 10 wt %, at least 15 wt % or at least 20 wt % of a thermoplastic material.

In another embodiment the first material includes 10-40 wt %, 15-35 wt %, or 20-30 wt % of a thermoplastic material.

In yet another embodiment the first material includes 10-70 wt %, 20-60 wt % or 25-50 wt % of a thermoset material.

In yet another embodiment the first material include at least 50 wt %, at least 60 wt % or at least 70 wt % of a mineral based material.

In an embodiment, the second layer comprises at least one or more of a thermoplastic material, a thermoset material, or a combination thereof. These types of materials have excellent insulating properties as they have a low thermal conductivity.

In another embodiment the second layer comprises a filler, comprises at least one or more of an organic filler, an inorganic filler or a combination thereof. Fillers have the advantages of e.g. improving layer properties such as thermal conductivity, material stability in the layer, etc. and often being cost efficient.

In yet another embodiment the filler is calcium carbonate (CaCO₃). This type of filler is especially cost efficient and easy to get a hold of and it also decreases movements in the material if exposed to external heat, compared to a layer made of only a thermoplastic or thermoset material. The thermally insulating layer may include 1-40 wt. % calcium carbonate (CaCO₃).

In an embodiment, the filler may comprise gas-containing elements, such as glass bubbles. The advantage of gas-containing elements is that the thermal conductivity of the insulating layer is decreased even more, increasing the insulating ability of the layer. The thermally insulating layer may include 1-20 wt. % gas-containing elements, or 5-15 wt. % gas-containing elements.

In yet another embodiment the second layer comprises a filler comprising a combination of calcium carbonate (CaCO₃) and gas-containing elements. By combining two different fillers, such as chalk/calcium carbonate and gas-containing elements the thermally insulating layer can be formed having several desirable features. for example, the thermal conductivity may be decreased by the gas-containing elements and the chalk/calcium carbonate can lower the cost of the thermally insulating layer.

In another embodiment, the thermally insulating layer include 30-70 wt. % of an organic filler. Organic fillers are often cost efficient and easy to get a hold of. They can also decrease the thermal conductivity of the layer.

In an embodiment the thermally insulating layer has a lower thermal conductivity than the core.

In an embodiment, the thermally insulating layer has a thermal conductivity of less than 1 W/mK, preferably a thermal conductivity of less than 0.8 W/mK, and more preferably a thermal conductivity of less than 0.5 W/mK The insulating layer may have a thickness of 0.1-3 mm, preferably a thickness of 0.2-2 mm, and even more preferably thickness of 0.5-1.5 mm.

In another embodiment, the method further comprising:
joining a fourth material to the first material opposite the second material, to form a fourth layer of the semi-finished panel. The fourth layer may form a second thermally insulating layer between the first layer and the applied heat and pressure when forming the building panels.

An advantage of having a further layer on the opposite side of the first layer is to either balance the building panel and to avoid e.g. shape deformations of the panel, such as cupping and/or to insulate the core from both sides. This is especially beneficial if heat and pressure is applied from both sides of the building panel during the manufacturing process, in order to insulate and protect the first layer.

### BRIEF DESCRIPTION OF THE DRAWING

Embodiments of the inventive concept will be described in the following; reference being made to the appended drawings which illustrate non-limiting embodiments of how the inventive concept can be reduced into practice.

FIG. 1 schematically illustrate a building panel such as a flooring panel according to an embodiment of the present inventive concept,

FIG. 2 illustrates a detailed view of the building panel in FIG. 1,

FIG. 3 illustrates a building panel with a décor layer according to an embodiment of the inventive concept,

FIGS. 4a-4b schematically illustrate a method to produce a building panel without a balancing layer, according to an embodiment of the present inventive concept,

FIGS. 5a-5b schematically illustrate a method to produce the building panel in FIG. 1, with a balancing layer, according to an embodiment of the present inventive concept,

FIGS. 6a-6b schematically illustrate a method to produce a building panel without a balancing layer, according to an embodiment of the present inventive concept,

FIGS. 7a-7b schematically illustrate a method to produce a building panel with a balancing layer, according to an embodiment of the present inventive concept, and

FIGS. 8a and 8b are illustrative charts of the results of the examples.

### DETAILED DESCRIPTION OF EMBODIMENTS

Although the inventive concept will be described below with reference to specific embodiments, it is not intended to be limited to the specific form set forth herein. Rather, the inventive concept is limited only by the accompanying claims. Other embodiments than the specific above are equally possible within the scope of the appended claims.

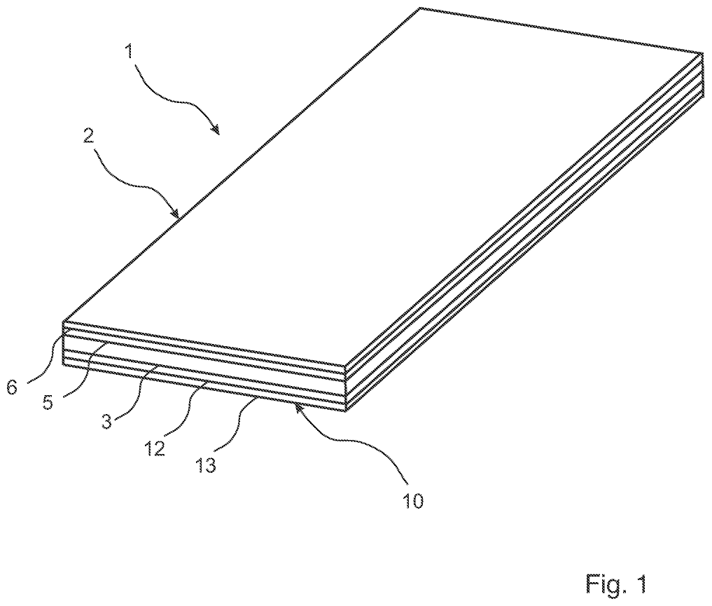

In FIG. 1 a building panel 1 is illustrated. The building panel 1 may be a flooring panel, a ceiling panel, a wall panel, a door panel, a worktop, a furniture component, skirting boards, etc. The building panel 1 includes a first layer 3, from now on called a core 3, and a layer arrangement 2, also called a first layer arrangement 2.

The core 3 comprises at least one or more of a thermoplastic material, a thermoset material, a mineral based material or a combination thereof.

Examples of suitable thermoplastic materials are polyvinyl chloride (PVC), polyethylene terephthalate (PET), polyvinyl butyral (PVB), polybutylene terephthalate (PBT), polyethylene (PE), polyester, polystyrene (PS), polypropylene (PP), polycarbonate (PC), polyvinyl acetate (PVAc), ethylene-vinyl acetate (EVA), polyacrylate, methacrylate, acrylonitrile butadiene styrene (ABS), thermoplastic polyurethane (TPU), and/or a combination thereof.

A core based on a thermoplastic material may include at least 10 wt %, at least 15 wt % or at least 20 wt % of the thermoplastic material. Such core may further include an inorganic filler of at least 50 wt %, at least 60 wt % or at least 65 wt %. Such core may further include additives.

A SPC core, which may be included in the inventive concept of the application, may include 10-40 wt %, 15-35 wt %, or 20-30 wt % of a thermoplastic material, such as PVC. The SPC core may further include 50-90 wt %, 60-80 wt % or 65-75 wt % of an inorganic filler, such as chalk. The SPC core may further include 0-20 wt %, 1-15 wt % or 2-10 wt % of additives, such as impact modifier, stabilizer, lubricant and/or pigment.

A LVT type of panel would have a similar content of material as the SPC core above, i.e. 10-40 wt %, 15-35 wt %, or 20-30 wt % of a thermoplastic material, 50-90 wt %, 60-80 wt % or 65-75 wt % of an inorganic filler and 0-20 wt %, 1-15 wt % or 2-10 wt % of additives, but with the addition of 1-20 wt %, 2-15 wt % or 3-10 wt % of a plasticizer.

Examples of suitable thermoset material are epoxy, polyurethane, cross-linked polyethylene (PEX), amino plastics, phenolic plastics, acrylates and/or a combination thereof.

A core based on a thermoset material may include 10-70 wt %, 20-60 wt % or 25-50 wt % of a thermoset resin, such as aminoplastics, polyurethanes, phenoplastics, epoxy or acrylics. Such core may further include 0-70 wt %, 10-70 wt % or 20-70 wt % of a filler, such as an inorganic filler. Such core may further include one or more additives, such as impact modifier, stabilizer, lubricant and/or pigment.

An example of a suitable mineral based material is magnesium oxide (MgO), magnesium chloride (MgCl2), magnesium sulfate (MgSO4), or sand. A core based on these types of mineral materials may further include 1-20 wt % or 5-15 wt % filler, such as an organic filler e.g. wood fibres.

Another type of suitable mineral based material is e.g. Portland cement. A core based on this type of mineral material may be called a fibre cement board, may further include sand and/or 1-20 wt % or 5-15 wt % filler, such as an organic filler e.g. wood fibres.

A core based on a mineral based material may include at least 50 wt %, at least 60 wt %, at least 70 wt %, or at least 80 wt % of the mineral based material.

The core 3 may further include a filler, as described above in the examples of each core type. The filler may be an organic filler, an inorganic filler or a combination thereof. Examples of an inorganic fillers are calcium carbonate (CaCO₃), barium sulphate (BaSO₄), or talc and/or a combination thereof. The core 3 may comprise, e.g., more than 50 wt. % of such an inorganic filler, or even more than 70 wt. % of such a filler. An example of an organic filler is wood fibres, as described above.

The layer arrangement 2 is arranged on one side of the core 3, in the illustrated example on the upper side of the core 3. The layer arrangement comprises a second layer 5, from now on called the thermally insulating layer 5, and a third layer 6, from now on called the surface layer 6. The thermally insulating layer 5 is located between the core 3 and the surface layer 6 such that, at least during the manufacturing process of the building panel 1, the thermally insulating layer 5, having significant heat insulation properties, insulating the core from external heat applied, for example on the surface layer 6, during the manufacturing process.

The thermally insulating layer 5 comprises at least one or more of a thermoplastic material, a thermoset material, or a combination thereof. Examples of suitable thermoplastic materials are polyvinyl chloride (PVC), polyethylene terephthalate (PET), polyvinyl butyral (PVB), polybutylene terephthalate (PBT), polyethylene (PE), polyester, polystyrene (PS), polypropylene (PP), polycarbonate (PC), polyvinyl acetate (PVAc), ethylene-vinyl acetate (EVA), polyacrylate, methacrylate, acrylonitrile butadiene styrene (ABS), thermoplastic polyurethane (TPU), and/or a combination thereof. Examples of suitable thermoset materials are epoxy, polyurethane, cross-linked polyethylene (PEX), amino plastics, phenolic plastics, acrylates and/or a combination thereof.

A purpose of the thermally insulating layer 5 is to protect the core 3 and prevent deformation of the core 3, at least during the manufacturing process, due to heat and pressure applied during the manufacturing process, as explained in more detail below. Therefore, the suitable material of the thermally insulating layer 5 is chosen to have a low thermal conductivity such that a limited amount of heat is transferred from the heat source to the core 3 during the manufacturing process. A thermoplastic material, a thermoset material or a combination thereof have great thermal conductivity for the desired purpose. To decrease the thermal conductivity of the thermally insulating layer even more 5 one or several fillers may be added, as explained in more detail below.

A core 3 made of one or more of the above presented materials may in different way be affected by heat. For example, a core made of PVC filled with calcium carbonate (chalk) easily deforms as it reaches higher temperatures, e.g. temperatures above 100° C.

The thermally insulating layer 5 has a thermal conductivity of less than 1 W/mK, a thermal conductivity of less than 0.8 W/mK, or a thermal conductivity of less than 0.5 W/mK.

Further, the thermally insulating layer 5 has a lower thermal conductivity than the core 3, for example, a thermal conductivity at least 0.1 W/mK lower, at least 0.2 W/mK lower, at least 0.3 W/mK lower or at least 0.4 W/mK lower. Hence, the core will be protected from the heat and in turn be protected from being deformed. For example, a typical SPC core has a thermal conductivity value of about 0.88 W/mK and a preferred thermal conductivity value of the thermally insulating layer would thus be lower than 0.78 W/mK, lower than 0.68 W/mK, lower than 0.58 W/mK or lower than 0.48 W/mK.

The thermally insulating layer 5 may further include at least one filler. The filler may decrease the thermal conductivity further, lower the cost of the layer, lower the weight of the layer, be reinforcing, improve the processability, decrease the risk of movement in the material of the layer when heat and/or pressure is applied, and/or provide better surface properties of the thermally insulating layer 5. The filler may either be an organic filler, an inorganic filler, or a combination thereof.

A thermally insulating layer 5 having no filler, may from a thermal conductivity point of view or a weight point of view be more desirable than having, e.g., a thermally insulating layer 5 comprising chalk, as can be seen in the Examples below, in Table 2 and 4. However, chalk may have other desirable features such as lower costs or decreased risk of movement in the layer when heat is applied. When comparing different types of filler, or lack of filler, an often used layer is the PVC blend with 50 wt. % chalk will be the reference layer to compare against. However, the decision of the content of a desirable thermally insulating layer 5 may also depend on what type of core 3 the building panel 1 will have.

An organic filler may be wood flour and/or rice husks. It may also be a filler made of coconut fibres, straw, flax or bagasse or the like. These types of organic fillers are often accessible and easy to get hold of to a favorable price. Using one or more of these organic fillers the thermally insulating layer 5 preferably comprises 30-70 wt. % filler.

An inorganic filler may be chalk/calcium carbonate (CaCO₃), barium sulphate (BaSO₄), talc, and/or a combination thereof. E.g., calcium carbonate (CaCO₃) has the advantages of being cost efficient, accessible and easy to handle. A preferred amount of calcium carbonate (CaCO₃) as a filler in the thermally insulating layer 5 is 1-40 wt % or 5-35 wt %. The more chalk added to the thermally insulating layer 5, the higher thermal conductivity.

Another inorganic filler which can be used in the thermally insulation layer 5 are gas-containing elements. These elements are able to contain gas such as air or any other desired gas. By having the gas-containing elements in the thermally insulating layer 5 the thermal conductivity of the insulating layer 5 is decreased due to the poor thermal conductivity of gases, thus, increasing the insulation properties of the layer 5. The gas-containing elements may be hollow particles such as glass bubbles and/or hollow particles of a polymer-based material or other suitable materials.

Tests have shown, see Example 1 below, that glass bubbles as a filler are excellent to use even in low amounts in order to decrease the thermal conductivity of the thermally insulating layer 5. This type of filler, the glass bubbles, may further be combined with other types of fillers in order to achieve other desirable features of the insulating layer 5, not only with regards to the thermal conductivity, but also with regards to costs, weight and other desirable layer properties as explained above.

Using only a gas-containing element filler the thermal insulating layer 5 preferably comprises 1-20 wt. % of such filler, or 5-15 wt. % of such filler.

Using a gas containing element filler together with another filler the preferred amount (wt. %) of such gas containing element filler may be different.

However, for example, if the other filler is chalk a preferred amount of gas-containing element filler in the thermal insulating layer 5 is 1-20 wt. % or 5-15 wt. % and the preferred amount of chalk is 1-40 wt % or 5-35 wt %.

The thermally insulating layer 5 further has a preferred thickness of 0.1-3 mm, more preferably a thickness of 0.2-2 mm, and even more preferably thickness of 0.5-1.5 mm. The thickness affects the amount of heat getting through the insulating layer 5 to the core 3, the thicker the better thermal insulation, but due to other aspects such as, for example, costs, material consumption, weight of the building panel, etc., the thickness of the insulation layer 5 is preferably within the presented ranges.

On the side of the thermally insulating layer 5 opposite the core 3 the surface layer 6 is arranged. The surface layer 6 comprises at least one or more of a thermoplastic material, a thermoset material or a combination thereof.

Examples of suitable thermoplastic materials are polyvinyl chloride (PVC), polyethylene terephthalate (PET), polyvinyl butyral (PVB), polybutylene terephthalate (PBT), polyethylene (PE), polyester, polystyrene (PS), polypropylene (PP), polycarbonate (PC), polyvinyl acetate (PVAc), ethylene-vinyl acetate (EVA), polyacrylate, methacrylate, acrylonitrile butadiene styrene (ABS), thermoplastic polyurethane (TPU), and/or a combination thereof.

Examples of suitable thermoset materials are epoxy, polyurethane, cross-linked polyethylene (PEX), amino plastics, phenolic plastics, acrylates and/or a combination thereof.

Further, the surface layer 6 may include a filler in order to lower the cost of the layer, to be reinforcing, to improve the processability or to provide better surface properties of the surface layer 6. The filler may be at least one or more of an organic filler, an inorganic filler, or a combination thereof.

An organic filler may be wood flour and/or rice husks. It may also be a filler made of coconut fibres, straw, flax or bagasse or the like. These types of organic fillers are often accessible and easy to get hold of to a favorable price. A preferred amount of an organic filler is 1-70 wt %, such as 5-70 wt %, more preferably 30-70 wt %. By not having more than 70 wt % organic filler the layer is less prone to swell but by having as much organic filler as possible the weight of the surface layer 6 and in turn the weight of the building panel is decreased. By having 30 wt % or more of the organic filler in the surface layer 6 advantages like lower weight, lower price and less carbon footprint may be achieved.

An inorganic filler may be chalk/calcium carbonate (CaCO₃), barium sulphate (BaSO₄), or talc and/or a combination thereof. E.g., calcium carbonate (CaCO₃) has the advantages of being cost efficient, accessible and easy to handle.

The surface layer 6 may either be a homogeneous layer or comprise two or more layers in turn. The surface layer 6 may be seen as the top layer facing the user as the building panel 1 is installed. Due to the surface layer 6 facing the user it may include a décor layer 8, an example is illustrated in FIG. 3, such as a coloured powder layer, a paper sheet, a polymer-based sheet, a wood-based veneer, a cork-based veneer or a fabric, woven or non-woven.

The thermally insulating layer 5 does not only protect the core 3 and prevent it from deforming during the manufacturing process it also contributes to achieving an even better and more reproducible surface layer 6. By having the thermally insulating layer 5 a deformation of the core 3 is prevented when heat and pressure is applied during the manufacturing process which in turn means that it possible to produce more even and reproduceable surface layers and building panels instead of having to take the deformation of the core 3, which may not always be predictable, into account during the manufacturing process. This will especially be beneficial when the surface layer 6 includes a décor layer 8 since the reproducibility may be revealed by the décor layer 8 when comparing two building panels which should, in theory, be basically identical.

Further, the surface layer 6 may include a protective layer (not shown), such as a lacquer or similar.

Yet further, the surface layer 6 may include a wear layer (not shown). The wear layer may either be a thermoplastic foil or a layer having wear resistant particles and/or scratch resistant particles. An example of such wear resistant particles and/or scratch resistant particles are aluminum oxide particles.

In order to give the layers their desired features either the thermally insulation layer 5, the surface layer 6 or both may comprise a thermosetting binder. Examples of a thermosetting binder are amino resins, for example melamine formaldehyde, urea formaldehyde or a combination thereof, or co-polymers. In an alternative embodiment a décor layer 8 of the surface layer 6, e.g. a paper sheet, may be impregnated with a thermosetting binder.

Further, as illustrated in FIGS. 1-3, the building panel 1 includes a second layer arrangement 10, arranged on the other side of the core 3, opposite the first layer arrangement 2. The second layer arrangement 10 comprises a balancing layer and may include either one or more layers.

The second layer arrangement 10 is an optional feature. In alternative embodiment the balancing properties of the building panel may be incorporated in the first layer arrangement 2 or core 3 before manufacturing the building panel 1, rendering the second layer arrangement unnecessary.

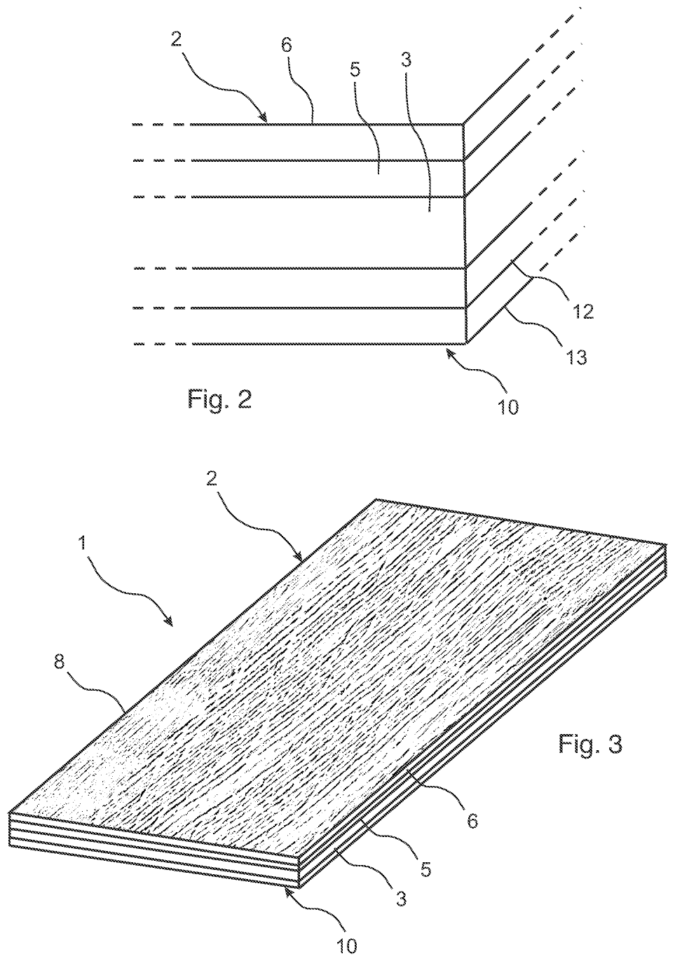

In the illustrated example, see FIGS. 1-2 the second layer arrangement 10 include two layers, an optional fourth layer from now on called the second thermally insulating layer 12, and a fifth layer from now on called the second surface layer 13. The second thermally insulating layer 12 is located between the core 3 and the second surface layer 13 such that, at least during the manufacturing process of the building panel 1, the second thermally insulating layer 12, having great insulation properties, insulating the core from external heat if applied on the second surface layer 6. The second layer arrangement 10 is provided to balance the other layers in the building panel 1 and provide a solid foundation of the building panel 1 providing durability and strength.

The second thermally insulating layer 12 may correspond to the thermally insulating layer 5 of the first layer arrangement 2 as explained above. All features and embodiments of the insulating layer 5 of the first layer arrangement 2 are applicable the second thermally insulating layer 12 in the second layer arrangement 10.

The second thermally insulating layer 12 comprises at least one or more of a thermoplastic material, a thermoset material, or a combination thereof.

Examples of suitable thermoplastic materials are polyvinyl chloride (PVC), polyethylene terephthalate (PET), polyvinyl butyral (PVB), polybutylene terephthalate (PBT), polyethylene (PE), polyester, polystyrene (PS), polypropylene (PP), polycarbonate (PC), polyvinyl acetate (PVAc), ethylene-vinyl acetate (EVA), polyacrylate, methacrylate, acrylonitrile butadiene styrene (ABS), thermoplastic polyurethane (TPU), and/or a combination thereof. Examples of suitable thermoset materials are epoxy, polyurethane, cross-linked polyethylene (PEX), amino plastics, phenolic plastics, acrylates and/or a combination thereof.

A purpose of the second thermally insulating layer 12 is to protect the core 3 from the opposite, rear side as well as the thermally insulating layer 5 does from the front side, and prevent deformation of the core 3, at least during the manufacturing process, due to heat and pressure as explained in more detail below. Therefore, the suitable material of the second thermally insulating layer 12 is, chosen to have a low thermal conductivity such that a limited amount of heat will be transferred to the core 3, e.g., during the manufacturing process. A thermoplastic material, a thermoset material or a combination thereof have great thermal conductivity for the desired purpose. As explained above, a core 3 made of one or more of the above presented materials may in different way be affected by heat.

The second thermally insulating layer 12 has a thermal conductivity of less than 1 W/mK, preferably a thermal conductivity of less than 0.8 W/mK, and more preferably a thermal conductivity of less than 0.5 W/mK. Further, the second thermally insulating layer 12 has a lower thermal conductivity than the core 3. Hence, the core will be protected from the heat and in turn be protected from being deformed.

The second thermally insulating layer 12 may further include a filler. The filler may decrease the thermal conductivity further, lower the cost of the layer, be reinforcing, improve the processability, and/or provide better surface properties of the thermally insulating layer 12. The filler may either be an organic filler, an inorganic filler or a combination thereof. The second insulating layer 12 preferably comprises 1-50 wt. % filler, such 5-50 wt. % filler.

An organic filler may be wood flour and/or rice husks. It may also be a filler made of coconut fibres, straw, flax or bagasse or the like. These types of organic fillers are often accessible everywhere and therefore easy to get hold of.

An inorganic filler may be chalk/calcium carbonate (CaCO₃), barium sulphate (BaSO₄), or talc and/or a combination thereof. E.g., calcium carbonate (CaCO₃) has the advantages of being cost efficient, accessible and easy to handle. A preferred amount of calcium carbonate (CaCO₃) as a filler in the second thermally insulating layer 12 is 1-40 wt %. Another inorganic filler which can be used also in the second thermally insulation layer 12 are gas-containing elements. These elements are able to contain gas such as air or any other desired gas. By having the gas-containing elements in the second thermally insulating layer 12 the thermal conductivity of the second thermally insulating layer 12 is decreased due to the poor thermal conductivity of gases, thus, increasing the insulation properties of the second thermally insulating layer 12. The gas-containing elements may be hollow particles such as glass bubbles and/or hollow particles of a polymer-based material or other suitable materials.

The second thermally insulating layer 12 further has a preferred thickness of 0.1-3 mm, more preferably a thickness of 0.2-2 mm, and even more preferably thickness of 0.5-1.5 mm. The thickness affects the amount of heat getting through the second insulating layer 12 to the core 3, the thicker the better thermal conductivity, but due to other aspects such as, for example, costs, material consumption, weight of the building panel, etc., the thickness of the second thermally insulation layer 12 is preferably within the presented ranges.

On the side of the second thermally insulating layer 12 opposite the core 3 the second surface layer 13 is arranged.

The second surface layer 13 may correspond to the surface layer 6 of the first layer arrangement 2 as explained above. All features and embodiments of the surface layer 6 of the first layer arrangement 2 are applicable the second surface layer 13 in the second layer arrangement 10.

The second surface layer 13 comprises at least one or more of a thermoplastic material, a thermoset material or a combination thereof.

Examples of suitable thermoplastic materials are polyvinyl chloride (PVC), polyethylene terephthalate (PET), polyvinyl butyral (PVB), polybutylene terephthalate (PBT), polyethylene (PE), polyester, polystyrene (PS), polypropylene (PP), polycarbonate (PC), polyvinyl acetate (PVAc), ethylene-vinyl acetate (EVA), polyacrylate, methacrylate, acrylonitrile butadiene styrene (ABS), thermoplastic polyurethane (TPU), and/or a combination thereof. Examples of suitable thermoset materials are epoxy, polyurethane, cross-linked polyethylene (PEX), amino plastics, phenolic plastics, acrylates and/or a combination thereof.

Further, the second surface layer 13 may include a filler in order to lower the cost of the layer, to be reinforcing, to improve the processability or to provide better surface properties of the second surface layer 13. The filler may be at least one or more of an organic filler, an inorganic filler, or a combination thereof.

An organic filler may be wood flour and/or rice husks. It may also be a filler made of coconut fibres, straw, flax or bagasse or the like. These types of organic fillers are often accessible and easy to get hold of to a favorable price. A preferred amount of an organic filler is 1-70 wt %, such as 5-70 wt %, more preferably 30-70 wt %. By not having more than 70 wt % organic filler the layer is less prone to swell but by having as much organic filler as possible the weight of the second surface layer 13 and in turn the weight of the building panel is decreased. By having 30 wt % or more of the organic filler in the second surface layer 13 advantages like lower weight, lower price and less carbon footprint is achieved.

An inorganic filler may be chalk/calcium carbonate (CaCO₃), barium sulphate (BaSO₄), or talc and/or a combination thereof. E.g. calcium carbonate (CaCO₃) has the advantages of being cost efficient, accessible and easy to handle.

The second surface layer 13 may either be a homogeneous layer or comprise two or more layers in turn. Since the second surface layer 13 is located on the rear side of the building panel 1, facing away from the user, a décor layer is probably not necessary but of course possible if desirable. As described above such a décor layer may be a coloured powder layer, a paper sheet, a polymer-based sheet, a wood-based veneer, a cork-based veneer or a fabric, woven or non-woven. However, in alternative embodiments, a powder layer, a paper sheet, a polymer-based sheet, a wood-based veneer, a cork-based veneer or a fabric, woven or non-woven, may be used, maybe not primarily for its appearance but for its strength and advantageous features to form a desirable balancing layer. The same reasoning may be applied to any of the presented décor layers.

In order to give the layers of the second layer arrangement 10 their desired feature either the second thermally insulation layer 12, the second surface layer 13 or both may comprise a thermosetting binder. Examples of a thermosetting binder are amino resins, for example melamine formaldehyde, urea formaldehyde or a combination thereof, or co-polymers. In an alternative embodiment, the second surface layer 13 may be, e.g., a paper sheet impregnated with a thermosetting binder.

In an alternative embodiment, the lower layer arrangement comprises only a single layer, preferably a second thermally insulating layer such that the core is protected from heat from both sides.

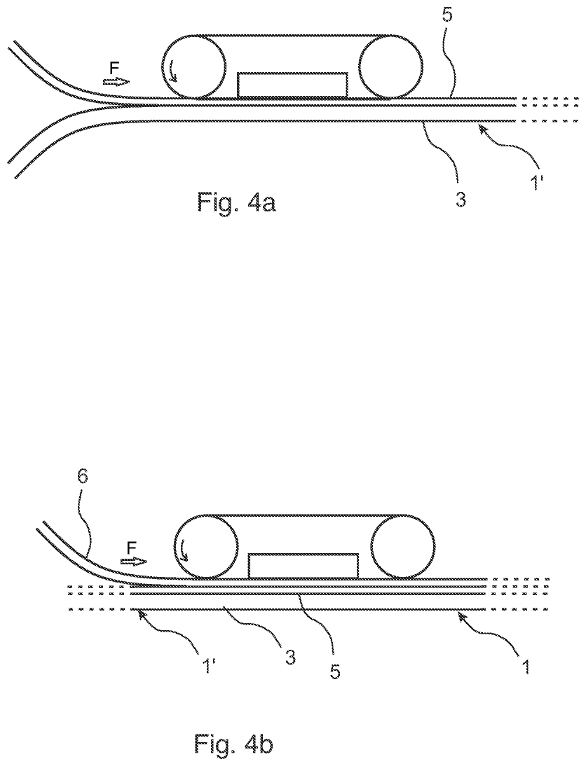

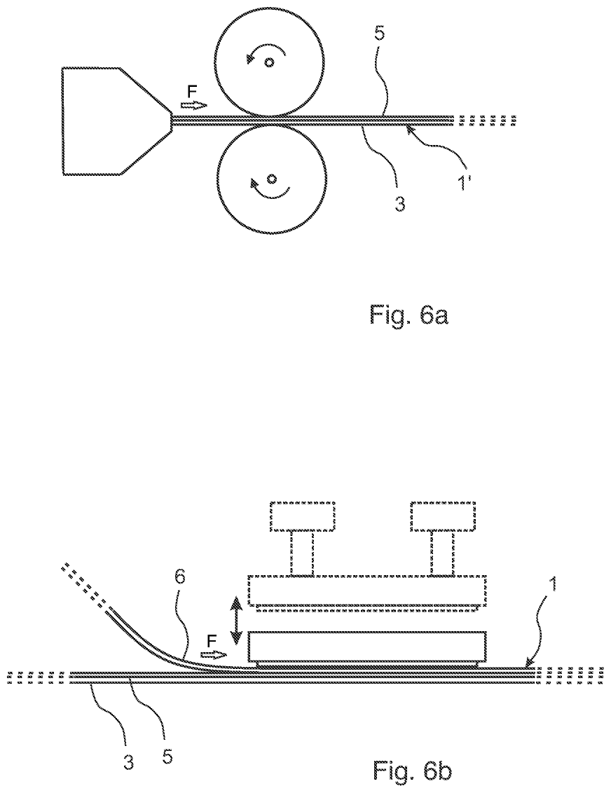

FIGS. 4a-4b and 6a-6b schematically illustrate a possible manufacturing process for making a building panel 1 as presented above. A method to manufacture the building panel 1, such as a floor panel, comprising the steps of:
joining a first material and a second material to form a first layer 3 and a second layer 5 of a semi-finished panel 1′, wherein the first material comprises at least one or more of a thermoplastic material, a thermoset material, a mineral based material or a combination thereof,
applying a third layer 6 on the second layer 5, and
applying heat and pressure to form the building panel 1,

wherein the first layer 3 forms a core of the building panel 1 and the third layer 6 forms a surface layer of the building panel 1, and

wherein the second layer 5 of the building panel 1 is a thermally insulating layer 5.

The first layer 3 is after the manufacturing process the core 3, as described above, of the finished building panel 1. The second layer 5 is after the manufacturing process the thermally insulating layer 5, as described above, of the finished building panel 1. The third layer 6 is after the manufacturing process the surface layer 6, as described above, of the finished building panel 1.

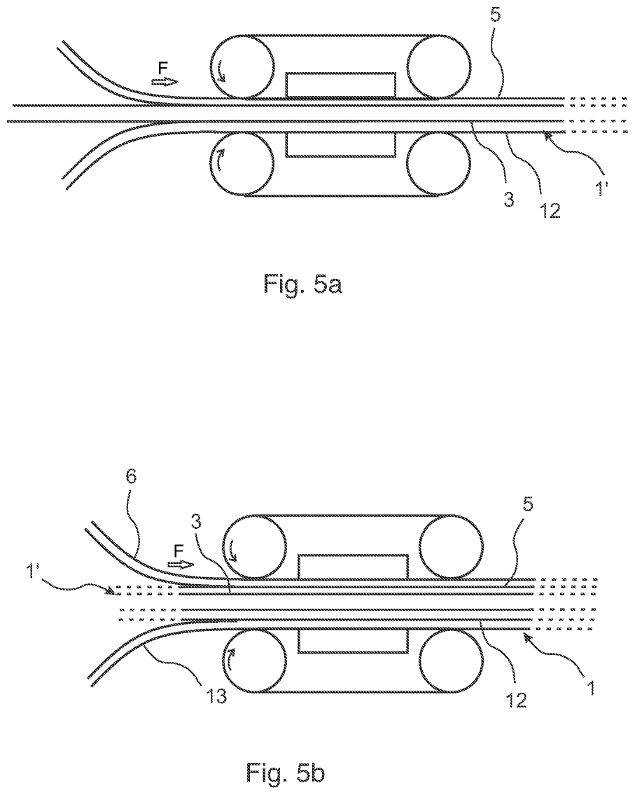

The thermally insulating layer 5, having significant heat insulation properties, insulating the first layer 3 from the heat applied during the manufacturing process when forming the building layer 1. A preferred temperature used in the method for manufacturing the building panel 1 is between 160 and 180° C. and a preferred pressure is between 20 and 50 bar, during a period of time of between 30 and 60 sec. These parameters are desired when using a short cycle press, schematically illustrated in FIGS. 4a and 4b. In another type of press, for example a double belt press the desirable parameters are similar to the short cycle press, possibly a bit lower pressure, about 10-60 bar and shorter time, about 20-60 seconds. A double belt press, schematically illustrated in FIGS. 5a and 5b, may be preferred to use due to its capacity and speed when producing such building panels.

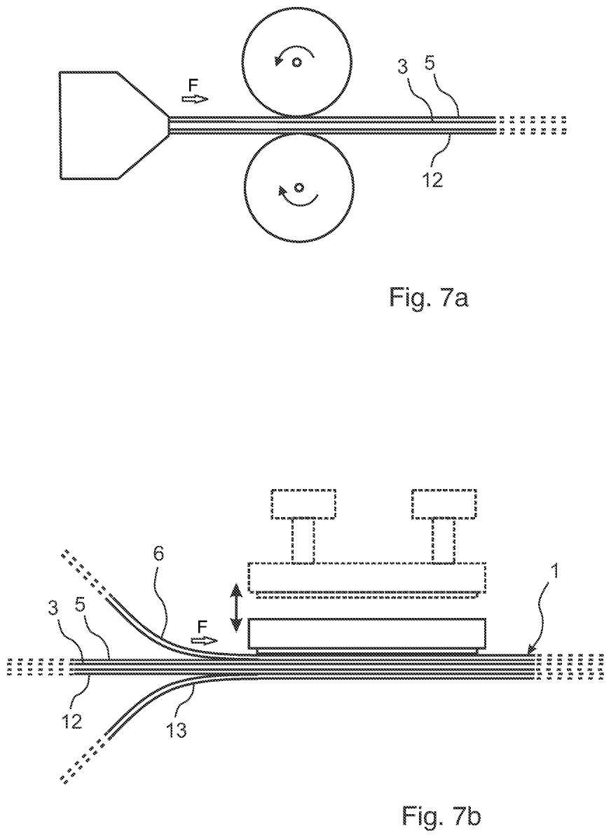

In other embodiments, the pressing process may include either a continuous pressing process or a discontinuous pressing process, schematically illustrated in FIGS. 6b and 7b. The pressing process may further include a stationary or mobile pressing device.

In an embodiment the joining of the first material and the second material may be made by an extrusion process, co-extrusion process and/or calendaring process to form the semi-finished panel, schematically illustrated in FIGS. 6a and 7a.

In an alternative embodiment the joining of the first material and the second material is made by a pressing process. The pressing process may include either a continuous pressing process or a discontinuous pressing process. The pressing process may further include a stationary or mobile pressing device.

The first layer 3 forms the core 3 of the finished building panel 1. The first material forming the first layer 3 comprises at least one or more of a thermoplastic material, a thermoset material, a mineral based material or a combination thereof.

Examples of suitable thermoplastic materials are polyvinyl chloride (PVC), polyethylene terephthalate (PET), polyvinyl butyral (PVB), polybutylene terephthalate (PBT), polyethylene (PE), polyester, polystyrene (PS), polypropylene (PP), polycarbonate (PC), polyvinyl acetate (PVAc), ethylene-vinyl acetate (EVA), polyacrylate, methacrylate, acrylonitrile butadiene styrene (ABS), thermoplastic polyurethane (TPU), and/or a combination thereof.

A first material based on a thermoplastic material may include at least 10 wt %, at least 15 wt % or at least 20 wt % of the thermoplastic material. Such first material may further include an inorganic filler of at least 50 wt %, at least 60 wt % or at least 65 wt %. Such a first material may further include additives.

A SPC layer, which may be included in the inventive concept of the application, may include 10-40 wt %, 15-35 wt %, or 20-30 wt % of a thermoplastic material, such as PVC. The SPC layer may further include 50-90 wt %, 60-80 wt % or 65-75 wt % of an inorganic filler, such as chalk. The SPC layer may further include 0-20 wt %, 1-15 wt % or 2-10 wt % of additives, such as impact modifier, stabilizer, lubricant and/or pigment.

A LVT type of layer would have a similar content of material as the SPC layer above, i.e. 10-40 wt %, 15-35 wt %, or 20-30 wt % of a thermoplastic material, 50-90 wt %, 60-80 wt % or 65-75 wt % of an inorganic filler and 0-20 wt %, 1-15 wt % or 2-10 wt % of additives, but with the addition of 1-20 wt %, 2-15 wt % or 3-10 wt % of a plasticizer.

Examples of suitable thermoset material are epoxy, polyurethane, cross-linked polyethylene (PEX), amino plastics, phenolic plastics, acrylates and/or a combination thereof.

A first material based on a thermoset material may include 10-70 wt %, 20-60 wt % or 25-50 wt % of a thermoset resin, such as aminoplastics, polyurethanes, phenoplastics, epoxy or acrylics. Such a first material may further include 0-70 wt %, 10-70 wt % or 20-70 wt % of a filler, such as an inorganic filler. Such a first material may further include one or more additives, such as impact modifier, stabilizer, lubricant and/or pigment.

An example of a suitable mineral based material is magnesium oxide (MgO), magnesium chloride (MgCl2), magnesium sulfate (MgSO4), or sand. A first material based on these types of mineral materials may further include 1-20 wt % or 5-15 wt % filler, such as an organic filler e.g. wood fibres.

Another type of suitable mineral based material is e.g. Portland cement. A first material based on this type of mineral material, which may be called a fibre cement material, may further include sand and/or 1-20 wt % or 5-15 wt % filler, such as an organic filler e.g. wood fibres.

A first material based on a mineral based material may include at least 50 wt %, at least 60 wt %, at least 70 wt %, or at least 80 wt % of the mineral based material.

The first material may further include a filler, as described above in the examples of each material or layer type. The filler may be an organic filler, an inorganic filler or a combination thereof. Examples of an inorganic fillers are calcium carbonate (CaCO₃), barium sulphate (BaSO₄), or talc and/or a combination thereof. The first material may comprise, e.g., more than 50 wt. % of such an inorganic filler, or even more than 70 wt. % of such a filler. An example of an organic filler is wood fibres, as described above.

The second material, forming the second layer 5 (the thermally insulating layer) comprises at least one or more of a thermoplastic material, a thermoset material, or a combination thereof.

Examples of suitable thermoplastic materials are polyvinyl chloride (PVC), polyethylene terephthalate (PET), polyvinyl butyral (PVB), polybutylene terephthalate (PBT), polyethylene (PE), polyester, polystyrene (PS), polypropylene (PP), polycarbonate (PC), polyvinyl acetate (PVAc), ethylene-vinyl acetate (EVA), polyacrylate, methacrylate, acrylonitrile butadiene styrene (ABS), thermoplastic polyurethane (TPU), and/or a combination thereof. Examples of suitable thermoset materials are epoxy, polyurethane, cross-linked polyethylene (PEX), amino plastics, phenolic plastics, acrylates and/or a combination thereof.

The purpose of the second layer 5 is to protect the first layer 3 and prevent deformation of the first layer 3, at least during the manufacturing process, when heat and pressure is applied. Therefore, the suitable second material of the second layer 5 is chosen to have a low thermal conductivity such that a limited amount of heat transfers from the heat source to the first layer 3, e.g., during the manufacturing process. A thermoplastic material, a thermoset material or a combination thereof have great thermal conductivity for the desired purpose. To decrease the thermal conductivity of the thermally insulating layer even more 5 one or several fillers may be added, as explained in more detail below.

A first layer 3 made of one or more of the above presented materials may in different way be affected by heat. For example, a first layer 3 made of PVC filled with calcium carbonate easily deforms as it reaches higher temperatures, e.g. temperatures above 100.° C.

The resulting second layer 5 has a thermal conductivity of less than 1 W/mK, preferably a thermal conductivity of less than 0.8 W/mK, and more preferably a thermal conductivity of less than 0.5 W/mK. Further, the second layer 5 has a lower thermal conductivity than the first layer 3, for example, a thermal conductivity at least 0.1 W/mK lower, at least 0.2 W/mK lower, at least 0.3 W/mK lower or at least 0.4 W/mK lower. Hence, the core will be protected from the heat and in turn be protected from being deformed. For example, a typical SPC core has a thermal conductivity value of about 0.88 W/mK and a preferred thermal conductivity value of the thermally insulating layer would thus be lower than 0.78 W/mK, lower than 0.68 W/mK, lower than 0.58 W/mK or lower than 0.48 W/mK.

The second material may further include at least one filler in order to either decrease the thermal conductivity further, to lower the cost of the layer, to lower the weight of the layer, to be reinforcing, to improve the processability, to decrease the risk of movement in the material of the layer when heat and/or pressure is applied or to provide better surface properties of the insulating layer 5. The filler may either be an organic filler, an inorganic filler or a combination thereof.

A second material having no filler, may from a thermal conductivity point of view or a weight point of view be more desirable than having e.g. a thermally insulating layer 5 comprising chalk, as can be seen in the Examples below, in Table 2 and 4. However, chalk may have other desirable features such as lower costs or decreased risk of movement in the layer when heat is applied. When comparing different types of filler, or lack of filler, an often used layer is the PVC blend with 50 wt. % chalk will be the reference layer to compare against. However, the decision of the content of a desirable thermally insulating layer 5 will also depend on what type of core 3 the building panel 1 has. An organic filler may be wood flour and/or rice husks. It may also be a filler made of coconut fibres, straw, flax or bagasse or the like. These types of organic fillers are often accessible everywhere and therefore easy to get hold of. Using one or more of these organic fillers the thermally insulating layer 5 preferably comprises 30-70 wt. % filler.

An inorganic filler may be calcium carbonate (CaCO₃), barium sulphate (BaSO4), or talc and/or a combination thereof. E.g. calcium carbonate (CaCO3) has the advantages of being cost efficient, accessible and easy to handle. A preferred amount of calcium carbonate (CaCO₃) as a filler in the second layer 5 is 1-40 wt %. The more chalk added to the thermally insulating layer 5, the higher thermal conductivity.

Another inorganic filler which can be used in the second layer 5 are gas-containing elements. These elements are able to contain gas such as air or any other desired gas. By having the gas-containing elements in the second layer 5 the thermal conductivity of the second layer 5 is decreased due to the poor thermal conductivity of gases, thus, increasing the insulation properties of the layer 5. The gas-containing elements may be hollow particles such as glass bubbles and/or hollow particles of a polymer-based material or other suitable materials.

Tests have shown, see Example 1 below, that glass bubbles as a filler are excellent to use even in low amounts in order to decrease the thermal conductivity of the second layer 5. This type of filler, the glass bubbles, may further be combined with other types of fillers in order to achieve the desirable layer 5, not only with regards to the thermal conductivity, but also with regards to costs and other desirable layer properties as explained above.

Using only a gas-containing element filler the thermal insulating layer 5 preferably comprises 1-20 wt. % of such filler, or 5-15 wt. % of such filler.

Using a gas containing element filler together with another filler the preferred amount (wt. %) of such gas containing element filler may be different.

However, for example, if the other filler is chalk a preferred amount of gas-containing element filler in the thermal insulating layer 5 is 1-20 wt. %, or 5-15 wt. %.

The second layer 5 further has a preferred thickness of 0.1-3 mm, more preferably a thickness of 0.2-2 mm, and even more preferably thickness of 0.5-1.5 mm. The thickness affects the amount of heat getting through the second layer 5 to the first layer 3, the thicker the better thermal conductivity, but due to other aspects such as for example costs, material consumption, weight of the building panel etc. the thickness of the second layer 5 is preferably within the presented ranges.

The first material and the second material may be joined together by any suitable manufacturing process, e.g. an extrusion process, co-extrusion process and/or calendaring process, or by a pressing process, to form the first layer 3 and the second layer 5 of the semi-finished panel 1′, see FIGS. 4a and 6a.

The third layer 6, which is applied to the second layer 5 forms a surface layer 6 of the finished building panel 1. The third layer 6 comprises at least one or more of a thermoplastic material, a thermoset material or a combination thereof.

Examples of suitable thermoplastic materials are polyvinyl chloride (PVC), polyethylene terephthalate (PET), polyvinyl butyral (PVB), polybutylene terephthalate (PBT), polyethylene (PE), polyester, polystyrene (PS), polypropylene (PP), polycarbonate (PC), polyvinyl acetate (PVAc), ethylene-vinyl acetate (EVA), polyacrylate, methacrylate, acrylonitrile butadiene styrene (ABS), thermoplastic polyurethane (TPU), and/or a combination thereof. Examples of suitable thermoset materials are epoxy, polyurethane, cross-linked polyethylene (PEX), amino plastics, phenolic plastics, acrylates and/or a combination thereof.

Further, the third layer 6 may include a filler in order to lower the cost of the layer, to be reinforcing, to improve the processability or to provide better surface properties of the third layer 6. The filler may be at least one or more of an organic filler, an inorganic filler, or a combination thereof.

An organic filler may be wood flour and/or rice husks. It may also be a filler made of coconut fibres, straw, flax or bagasse or the like. These types of organic fillers are often accessible and easy to get hold of to a favorable price. A preferred amount of an organic filler is 1-70 wt %, more preferably 30-70 wt %. By not having more than 70 wt % organic filler the layer is less prone to swell but by having as much organic filler as possible the weight of the third layer 6 and in turn the weight of the building panel is decreased. By having 30 wt % or more of the organic filler in the third layer 6 advantages like lower weight, lower price and less carbon footprint is achieved.

An inorganic filler may be chalk/calcium carbonate (CaCO₃), barium sulphate (BaSO₄), or talc and/or a combination thereof. E.g. chalk/calcium carbonate (CaCO₃) has the advantages of being cost efficient, accessible and easy to handle.

The third layer 6 may either be a homogeneous layer or comprise two or more layers in turn. The third layer 6 may be seen as the top layer in the resulting building panel 1, facing the user as the building panel 1 is installed. Due to that the third layer 6 may include a décor layer 8, such as a coloured powder layer, a paper sheet, a polymer-based sheet, a wood-based veneer, a cork-based veneer or a fabric, woven or non-woven.

The second layer 5 does not only insulate the first layer 3 from heat preventing it from deforming during the manufacturing process it also contributes to achieving an even better and more reproducible third layer 6 of the finished building panel 1. By having the second layer 5, that prevents deformation of the first layer 3 when heat and pressure is applied, the manufacturing process will produce more even resulting surface layers and building panels instead of having to take the deformation of the first layer 3, which may not always be predictable, into account during the manufacturing process. This will especially be beneficial when the third layer 6 includes a décor layer 8 since the reproducibility may be revealed by the décor layer 8 when comparing two finished building panels which should, in theory, be basically identical.

Further, the third layer 6 may include a protective layer (not shown), such as a lacquer or similar.

Yet further, the third layer 6 may include a wear layer (not shown). The wear layer may either be a thermoplastic foil or a layer having wear resistant particles and/or scratch resistant particles. An example of such wear resistant particles and/or scratch resistant particles are aluminum oxide particles.

In order to give the layers their desired features either the second layer 5, the third layer 6 or both may comprise a thermosetting binder. Examples of a thermosetting binder are amino resins, for example melamine formaldehyde, urea formaldehyde or a combination thereof, or co-polymers. In an alternative embodiment a décor layer 8 of the third layer 6, e.g., a paper sheet, may be impregnated with a thermosetting binder.

The method may further comprise step/steps of applying a balancing layer 12, 13 and/or another thermally insulating layer on the other side of the first layer 3, opposite the second and third layer 5, 6, as schematically illustrated in FIGS. 5a and 5b. This layer may include either one or more layers.

The method may further comprise
joining a fourth material to the first material, opposite the second material, to form a fourth layer 12, wherein said fourth layer 12 forms a thermally insulating layer of said building panel 1, or
applying a fourth layer 12 on the first layer 3 opposite the second layer 5, wherein said fourth layer 12 forms a thermally insulating layer of the building panel 1.

In the first alternative, the fourth material may be joined with the first material either before, during or after the second material is joined with the first material. It may be joined by any suitable manufacturing process, e.g. an extrusion process, co-extrusion process and/or calendaring process, or by a pressing process, see FIGS. 5a and 7a. The pressing process may include either a continuous pressing process or a discontinuous pressing process. The pressing process may further include a stationary or mobile pressing device.

In the second alternative, the fourth material is applied to the already formed first layer and alternatively as an already finished layer, such as a paper sheet, a polymer-based sheet, a wood-based veneer, a cork-based veneer or a fabric, woven or non-woven. The fourth layer would be applied to the first layer and the preferably in a pressing process pressed together to form the building panel. The pressing process may include either a continuous pressing process or a discontinuous pressing process. The pressing process may further include a stationary or mobile pressing device.

In the example of a building panel 1 illustrated by FIG. 1 the method used for manufacturing the building panel 1 included applying a fifth layer 13 to the fourth layer 12. The fourth layer forms a second thermally insulating layer 12 between the first layer 3 and the applied heat and pressure, opposite the second layer 5. In this embodiment the fourth layer 12 and the fifth layer 13 together form the balancing layer of the building panel 1. Applying the fifth layer 13 to the fourth layer 12 is preferably made by a pressing process, see FIGS. 5b and 7b. The pressing process may include either a continuous pressing process or a discontinuous pressing process. The pressing process may further include a stationary or mobile pressing device.

The fourth layer 12 and/or the fifth layer 13 are optional features. In alternative embodiment the balancing properties of the building panel may be incorporated in the first layer or core 3 before manufacturing the building panel 1, rendering these layers unnecessary.

The fourth layer 12 and the fifth layer 13 may correspond to the second layer 5 and the third layer 6, as explained above, respectively. All features and embodiments of the second layer 5 and third layer 6 are applicable to the fourth layer 12 and the fifth layer 13 respectively.

Below are some tests presented showing the correlation between the amount of filler and the thermal conductivity for suitable sublayers.

In order to measure the thermal conductivity of the layers a thermal conductivity analyzer TCi from C-therm was used, (model/serial #TH91-13-00729 with sensor H461). The test was performed by dropping three drops of water onto the sensor with a pipette then putting the sample centered on the sensor with a 500 g weight on top to secure that the sample is in place during the measurements. After that the test was started. Ten measurements per sample were performed.

### Example 1: PVC-Based Sublayer

For the testing, a PVC blend was mixed with different fillers of different amounts. The PVC blend recipe is defined in Table 1. Most of the blend consists of PVC (68.97%) and a plasticizer (22.06%).

TABLE 1
PVC blend recipe
PVC blend recipe

| | PHR | |
|---|---|---|
| Raw material | (Parts per hundred resin) | Weight % |
| Norvinyl S5745 | 100 | 68.97% |
| Baerostab CT 1228 R | 10 | 6.90% |
| Baerolub PA Special | 2 | 1.38% |
| Baerolub PA 200 | 1 | 0.69% |
| Eastman 168 | 32 | 22.06% |
| Total: | 145 | 100% |

The PVC blend, according to Table 1, of 300 g was mixed with different amounts of fillers. Such fillers were calcium carbonate (CaCO₃), which is an inorganic filler often used in products such as building panels, different types of gas containing elements, e.g., Expancel®, which is polymer-based spheres or micro-spheres containing gas which expands under heat, or glass-based bubbles, which is able to contain air or wood flour, and organic filler which is commonly used in products such as building panels. Table 2 presents the correlation between the amount of the above presented fillers in a sublayer and the thermal conductivity of such a sublayer.

The reference example of a common layer used today is a layer comprising the PVC blend with 50 wt. % CaCO₃ (chalk), which is marked with a bold font in Table 2.

TABLE 2
Sublayer with the PVC blend and different
fillers vs. thermal conductivity

| | | Thermal conductivity |
|---|---|---|
| Sublayer | Weight % of Filler | [W/mK] |
| PVC blend + no filler | 0 | 0.241 |
| PVC blend + 25 g CaCO₃ | 8 | 0.266 |
| PVC blend + 50 g CaCO₃ | 14 | 0.288 |
| PVC blend + 100 g CaCO₃ | 25 | 0.324 |
| PVC blend + 200 g CaCO₃ | 40 | 0.492 |
| PVC blend + 300 g CaCO₃ | 50 | 0.600 |
| PVC blend + Expancel ® | 1 | 0.180 |
| PVC blend + Glass bubbles | 50 | 0.061 |
| PVC blend + wood flour | 44 | 0.378 |

By studying the results in Table 2, a conclusion is drawn that less CaCO₃ filler decreases the thermal conductivity, which is preferred for the thermally insulating layer, as presented above. A preferred amount of CaCO₃ filler in the thermally insulating sublayer would be less than 40 wt % but going as low as about 10 wt % the value of the thermal conductivity is halved, compared to the reference sublayer.

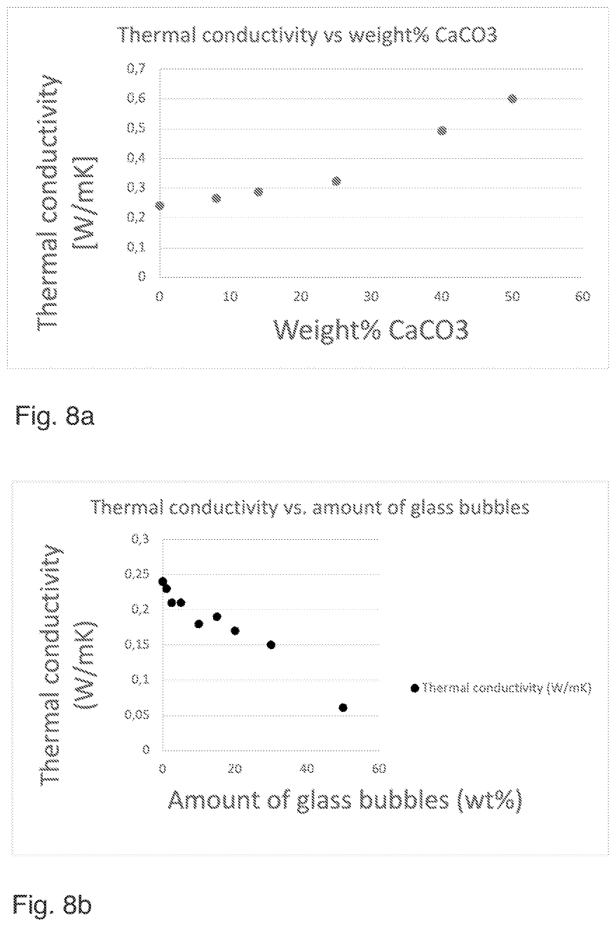

Yet another conclusion is that there is a correlation between the amount of CaCO₃ filler in the PVC blend and the thermal conductivity, which is illustrated in the graph in FIG. 8a.

Another conclusion to be drawn from the results in Table 2 is that organic fillers, in this case wood flour works excellent to decrease the thermal conductivity.

Yet another conclusion to be drawn from the results in Table 2, is that a surprising effect was achieved by the gas-containing element fillers, Expancel® and glass bubbles, which both resulted in a very low thermal conductivity. Therefore, further tests were made with different amounts of gas-containing elements, in this case glass bubbles (GB), as can be seen in Table 3.

TABLE 3
Sublayer with the PVC blend and glass
bubble filler vs. thermal conductivity

| | | Thermal conductivity |
|---|---|---|
| Sublayer | Weight % of GB | [W/mK] |
| PVC blend + 3 g GB | 1 | 0.23 |
| PVC blend + 7.5 g GB | 2.5 | 0.21 |
| PVC blend + 16 g GB | 5 | 0.21 |
| PVC blend + 33 g GB | 10 | 0.18 |
| PVC blend + 53 g GB | 15 | 0.19 |
| PVC blend + 75 g GB | 20 | 0.17 |
| PVC blend + 128 g GB | 30 | 0.15 |
| PVC blend + 300 g GB | 50 | 0.06 |

As can be seen in Table 3 and visualized in the graph in FIG. 8b, the thermal conductivity of the sublayer may be decreased even further by adding glass bubbles, both compared to the PVC blend with no filler but especially compared to the reference sublayer. The decrease in thermal conductivity is basically linear with an increased amount of filler.

Glass bubbles have a rather low density compared to the other possible fillers so amount 30 or 50 weight % of glass bubbles would mean a rather high volume %, compared to the other fillers. A preferred wt. % of glass bubbles in a thermally insulating layer would preferably be 1-20 wt. % GB, or 5-15 wt. % GB.

### Example 2: PP-Based Sublayer

For this testing, a PP blend was mixed with different. The PP blend recipe is defined in Table 4.

TABLE 4
PP blend recipe
PP blend recipe

| Material | Weight % |
|---|---|
| Sabic PP FPC 100 | 78% |
| Acti-Tech 05MA18 | 22% |
| Total: | 100% |

For further testing, the PP blend was mixed with different fillers, equal part PP blend and filler. Table 4 presents the correlation between the amount of the below presented fillers in a PP-based sublayer and the thermal conductivity of such a sublayer. The fillers in the test were the organic filler rice husk, the organic filler ground rice husk, the organic filler wood flour, the inorganic filler talc, the inorganic filler chalk and a mix of the inorganic fillers chalk and glass bubbles.

TABLE 55
Sublayer with PP blend and different
fillers vs. thermal conductivity

| | | Thermal conductivity |
|---|---|---|
| Sublayer | Weight % of Filler | [W/mK] |
| PP blend + rice husk | 50 | 0.393 |
| PP blend + ground rice | 50 | 0.524 |
| husk | | |
| PP blend + wood flour | 50 | 0.398 |
| PP blend + talc | 50 | 0.566 |
| PP blend + chalk | 50 | 0.59 |
| PP blend + chalk and glass | 25 (chalk) + 25 | 0.42 |
| bubbles | (glass bubbles) | |

A conclusion to be drawn from the results in Table 5, compared to Table 2, is, when comparing the thermal conductivity of a PVC-based sublayer having 50 wt % chalk (CaCO₃) and a PP-based sublayer having 50 wt % chalk, that the choice of thermoplastic material have a little effect on the thermal conductivity. The choice of filler is more crucial for creating the desirable thermally insulating layer with the desirable thermal conductivity.

Further, by studying the result in Table 5 it is concluded that rice husk achieves a lower thermal conductivity of the layer than ground rice husk. Further, rice husk and wood flour achieve basically the same thermal conductivity when mixed with the PP blend. Also the combination of chalk and glass bubbles achieves a thermal conductivity close to rice husk and wood flour.

Mixing the PP blend with ground rice husk, talc or chalk only still may achieve an acceptable thermal conductivity but not as low as the mix with rice husk, wood flour or chalk and glass bubbles.

1. A building panel, comprising:
a core comprising at least one or more of a thermoplastic material, a thermoset material, a mineral based material or a combination thereof,
a layer arrangement, arranged on one side of said core, comprising a surface layer and a thermally insulating layer, wherein said thermally insulating layer is arranged between said core and said surface layer.

2. The building panel according to claim 1, wherein the core comprises at least 10 wt % of a thermoplastic material.

3. The building panel according to claim 1, wherein the core comprises 10-40 wt % of a thermoplastic material.

4. The building panel according to claim 1, wherein the core comprises 10-70 wt % of a thermoset material.

5. The building panel according to claim 1, wherein the core comprises at least 50 wt % of a mineral based material.

6. The building panel according to claim 1, wherein the thermally insulating layer comprises at least one or more of a thermoplastic material, a thermoset material, or a combination thereof.

7. The building panel according to a claim 1, wherein said thermally insulating layer comprises a filler.

8. The building panel according to claim 7, wherein said filler comprises at least one or more of an organic filler, an inorganic filler, or a combination thereof.

9. The building panel according to claim 7, wherein said filler is calcium carbonate.

10. The building panel according to claim 9, wherein said thermally insulating layer comprises 1-40 wt. % calcium carbonate.

11. The building panel according to claim 7, wherein said filler comprises gas-containing elements.

12. The building panel according to claim 11, wherein said gas-containing elements are glass bubbles.

13. The building panel according to claim 11, wherein said thermally insulating layer comprises 1-20 wt. % gas-containing elements.

14. The building panel according to claim 7, wherein said thermally insulating layer comprises a filler comprising a combination of calcium carbonate and gas-containing elements.

15. The building panel according to claim 7, wherein said thermally insulating layer comprises 30-70 wt % of an organic filler.

16. The building panel according to claim 1, wherein the insulating layer has a lower thermal conductivity than the core.

17. The building panel according to claim 1, wherein the thermally insulating layer has a thermal conductivity of less than 1 W/mK.

18. The building panel according to claim 1, wherein the thermally insulating layer has a thickness of 0.1-3 mm.

19. The building panel according to claim 1, further comprising a second layer arrangement arranged on one side of the core, opposite of the first layer arrangement.

20. The building panel according to claim 19, wherein the second layer arrangement comprises a second surface layer and a second thermally insulating layer, wherein said second thermally insulating layer is arranged between said core and said second surface layer.

21. A method to manufacture a building panel, comprising:
joining a first material and a second material to form a first layer and a second layer of a semi-finished panel, wherein said first material comprises at least one or more of a thermoplastic material, a thermoset material, a mineral based material or a combination thereof,
applying a third layer on the second layer, and
applying heat and pressure to form said building panel,
wherein the first layer forms a core of the building panel and the third layer forms a surface layer of the building panel, and
wherein the second layer forms a thermally insulating layer between the first layer and the applied heat and pressure.

22. The method according to claim 21, wherein the first material comprises at least 10 wt % of a thermoplastic material.

23. The method according to claim 21, wherein the first material comprises 10-40 wt % of a thermoplastic material.

24. The method according to claim 21, wherein the first material comprises 10-70 wt % of a thermoset material.

25. The method according to claim 21, wherein the first material comprises at least 50 wt % of a mineral based material.

26. The method according to claim 21, wherein the second layer comprises at least one or more of a thermoplastic material, a thermoset material, or a combination thereof.

27. The method according to claim 21, wherein said second layer comprises a filler.

28. The method according to claim 27, wherein said filler comprises at least one or more of an organic filler, an inorganic filler or a combination thereof.

29. The method according to claim 27, wherein said filler is calcium carbonate.

30. The method according to claim 29, wherein said second layer comprises 1-40 wt % calcium carbonate.

31. The method according to claim 27, wherein said filler comprises gas-containing element.

32. The method according to claim 31, wherein said gas-containing elements are glass bubbles.

33. The method according to claim 31, wherein said second layer comprises 1-25 wt % gas-containing elements.

34. The building panel according to claim 27, wherein said second layer comprises a filler comprising a combination of calcium carbonate and gas-containing elements.

35. The method according to claim 27, wherein said second layer comprises 30-70 wt % of an organic filler.

36. The method according to claim 21, wherein the second layer has a lower thermal conductivity than the first layer.

37. The method according to claim 21, wherein the second layer has a thermal conductivity of less than 1 W/mK.

38. The method according to claim 21, wherein the second layer has a thickness of 0.1-3 mm.

39. The method according to claim 21, further comprising:
joining a fourth material to the first material, opposite the second material, to form a fourth layer of the semi-finished panel.

40. The method according to claim 39, wherein the fourth layer forms a thermally insulating layer between the first layer and the applied heat and pressure when forming said building panel.

41. A building panel obtainable by a method according to claim 21.
